(19) United States
(12) Patent Application Publication
(10) Pub. No.: US 2025/0160377 A1
(43) Pub. Date: May 22, 2025

(54) Method And Apparatus For Fermenting Pepper Mash

(71) Applicant: Christopher White, New Orleans, LA (US)

(72) Inventor: Christopher White, New Orleans, LA (US)

(21) Appl. No.: 18/957,633

(22) Filed: Nov. 22, 2024

Related U.S. Application Data
(60) Provisional application No. 63/601,748, filed on Nov. 22, 2023.

(51) Int. Cl. A23L 19/00

(52) U.S. Cl. CPC A23L 19/09

(57) ABSTRACT

The invention includes a method of fermenting pepper mash, where the method includes agitating the mash in a fermentation tank at times. The agitation can be continuous, on a schedule, or intermittently. The method also includes the step of pumping the pepper mash into the tank leaving a headspace of inches. The invention also includes an apparatus of agitating the pepper mash in a fermentation tank, where the apparatus includes an agitator located in the interior of the tank, where the agitator is coupled to a power source for operating the agitator.

### PRIORITY CLAIM

This application claims the priority benefit of U.S. provisional application 63/601,748, filed on Nov. 22, 2023, which is incorporated by reference.

### FIELD OF THE INVENTION

This invention related to methods of fermenting pepper mash and an apparatus for fermenting pepper mash where the method includes agitation of the pepper mash while fermenting.

### BACKGROUND OF THE INVENTION

Pepper mash is created by grinding or chopping de-stemmed fresh chilli peppers and adding 7-22% salt, where the salt dissolves and results in a pepper slurry called a mash. Each producer has a closely guarded recipe for its mash, including the mix of peppers, the degree of chop of the peppers, the amount of salt added, and the length of time to age the mash. The saltis added to discourage the proliferation of pathogens as the natural fermentation process occurs. During the fermentation process, naturally occurring Lactic Acid Bacteria (LAB) and yeast convert the pepper sugar into lactic acid, lowering the pH to make the pepper mash shelf stable and food safe. In order to achieve the condition of shelf stability, food safety, and to satisfy FDA requirements, the pH of the pepper mash must be at or below 4.6 before use. While scientific studies (“Microbiological changes and their impact on quality characteristics of red hot chilli pepper mash during natural fermentation”, International Journal of Food Science and Technology 2018, Vol. 53, 1816-1823, incorporated by reference) suggest that this can be accomplished with current static fermentation processes in 66 days, the industry has settled on a minimum aging/fermentation time of 90-180 days. Some producers age the mash for years. The pepper mash is fermented until a desired characteristic is achieved, such as pH, or fermentation time, or other characteristic. The requirement to age the pepper for this length of time creates the need for very large investments in infrastructure to include hundreds of large fermentation tanks.

Pepper mash fermentation takes place in a container, such as a large tank. The container is not filled but has a headspace that is left empty. The fermentation takes place in an anaerobic environment, so the container can be sealed, but generally it has a closed top. However, fermentation produces CO₂, and the fermentation tank may be vented to allow the produced gases to escape, which displaces any oxygen in the headspace. The tank vent is designed in a way to prevent the introduction of foreign material. During fermentation, the solids in the mash become buoyant due to entrained CO₂ and rise to fill the headspace.

The aging or fermentation container can be an oak barrel, such as is used by the McIlhenny Company in making its Tabasco brand hot sauce. Commercial mash producers generally use plastic, fiberglass, or stainless-steel tanks; these tanks are typically quite large. For instance, FIG. 1 shows one example of a tank used for fermentation. Once the fermentation is sufficiently complete to produce the desired mash pH, producers will then try to mix the pepper mash back to a homogenous state through a recirculation process using pumps typically rated for 200 GPM. Because of the high solids content and the non-Newtonian nature of the pepper mash, this is very difficult and time-intensive to accomplish. It is virtually impossible to achieve a completely homogenous mix in this fashion and therefore generally results in a delivered finished product where the customer cannot predict the pepper solids content, viscosity, and salt percentage. This has been an industry-wide problem in the pepper mash market for decades.

### SUMMARY OF THE INVENTION

The inventor has found that stirring, mixing, blending, or agitating the mash in the container during fermentation helps to keep the pepper mash in a more homogeneous state while fermenting. This helps speed the fermentation time by evenly distributing the microbiological activity in the pepper mash slurry, providing better availability to the pepper sugars that are consumed to create lactic acid. Agitation also helps to reduce particle size of the pepper mash due to shearing action of the mixing device. The agitators provide more pepper solids surface area and increase the pepper mash's viscosity. The mixing or agitation can be done intermittently or on a schedule (fixed or variable); for instance, mix for 1 hour, rest for 12 hours, or even mixing continuously, or any schedule found to produce the desired homogeneity, particle size and viscosity of the product. The mixing schedule can be changed as the fermentation process progresses. As used herein, mixing, agitation and blending are considered the same processes.

The invention also includes a pepper mash fermentation tank including an agitator on the tank, where the agitator is connectable to a power source, such as a motor.

### DESCRIPTION OF THE FIGURES

FIG. 1 is a front perspective side view of one embodiment of a mixing tank.

FIG. 2 is a flow graph of the pepper mash in the tank while under agitation using the agitator shown in in FIG. 4.

FIG. 3 is a top view of the mixing tank of FIG. 1 including a manway across the top of the tank.

FIG. 4 is a side view of one embodiment of an agitator.

### DETAILED DESCRIPTION OF THE INVENTION

The embodiments of the disclosure will be best understood by reference to the drawings, wherein like parts are designated by like numerals throughout. It will be readily understood that the components, as generally described and illustrated in the figures herein, could be arranged and designed in a wide variety of different configurations or be entirely separate. Thus, the following more detailed description of the embodiments of the system and method of the disclosure, as represented in the Figures, is not intended to limit the scope of the disclosure, as claimed, but is merely representative of possible embodiments of the disclosure.

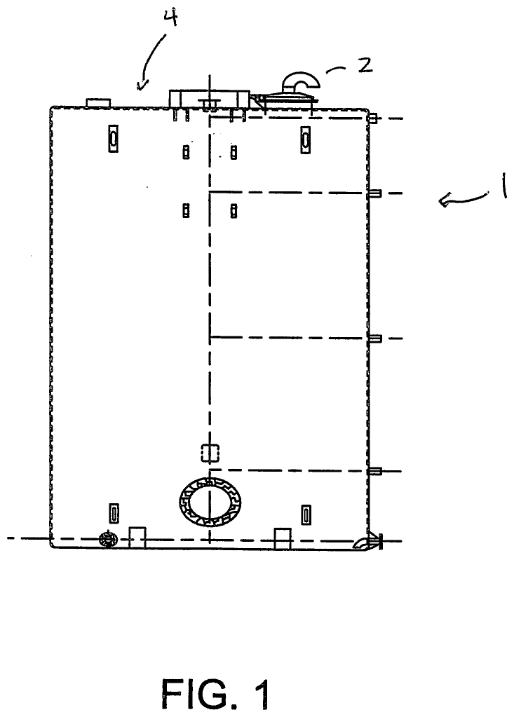

FIG. 1 depicts one embodiment of a pepper mash fermentation tank 1. The tank is a large fiberglass tank, 24.5 feet high and 14 feet in diameter capable of holding approximately 24,900 gallons with a headspace of about 4,000 gallons. The tank is vented by a vent 2 to allow CO₂ generated during fermentation to escape. This tank is loaded with approximately 200,000 pounds of freshly ground pepper mash

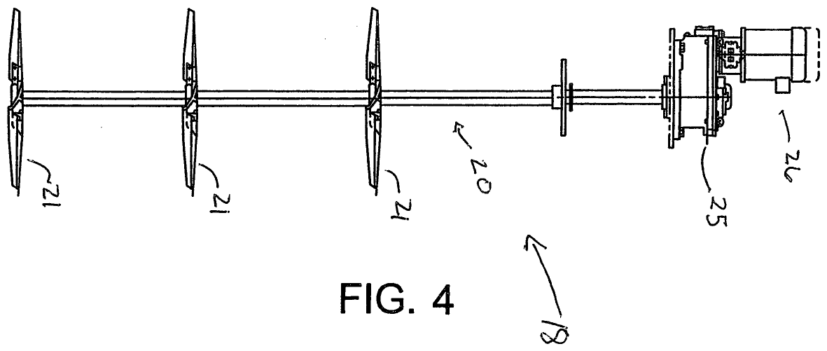

The tank in FIG. 1 includes an agitator, mixer, or blender. One embodiment is the agitator 18, a rotatable shaft 20 axially positioned in a center opening 5 of the tank (see FIG. 4). The shaft 20 of the agitator 18 includes three attached agitator impellers 21 (one in the top third, one in the middle third and one in the bottom third of the tank), with each impeller having a 77″ diameter (see FIG. 4). To mount the shaft 20 to the tank, the tank top portion 4 has a center opening 5 through which the top of the shaft 20 protrudes. The agitator shaft 20 extends through the top of the tank 4 through an agitator nozzle that utilizes an auxiliary packing seal to prevent the introduction of foreign material or escape of pepper mash.

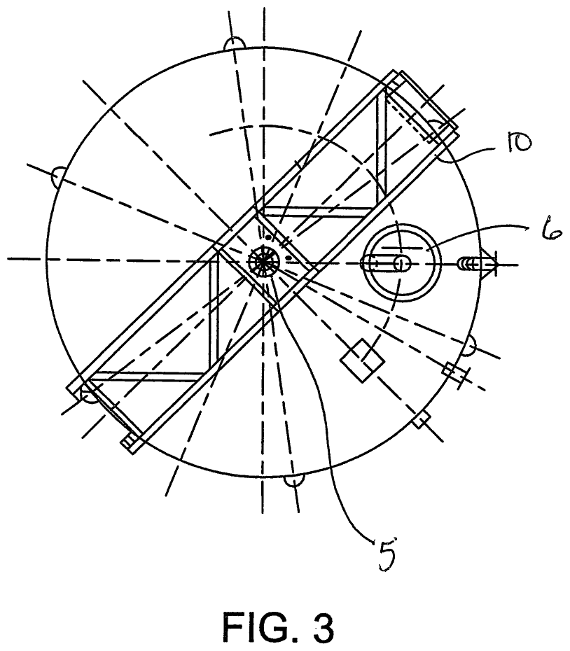

The agitator shaft 20 is coupled to a gearbox 25 with the appropriate output speed. The gearbox's power source here is an electric motor 26, preferably controlled with a variable frequency drive to allow for the optimum operation speed to produce the uniform homogeneity of the mash by the agitator. As shown in FIG. 3, the tank top 4 has an agitator manway bridge 10 to support the static weight and loads (bending movement and torque) of the agitator while operating, and to provide an area in which to service the components. The tank top 4 edge portion may have to be reinforced to support the manway. As shown in FIG. 3, the tank top 4 has a second sealable opening 5, accessible from the manway 10, to allow an operator to access the interior of the tank to assemble the impellers or service the device.

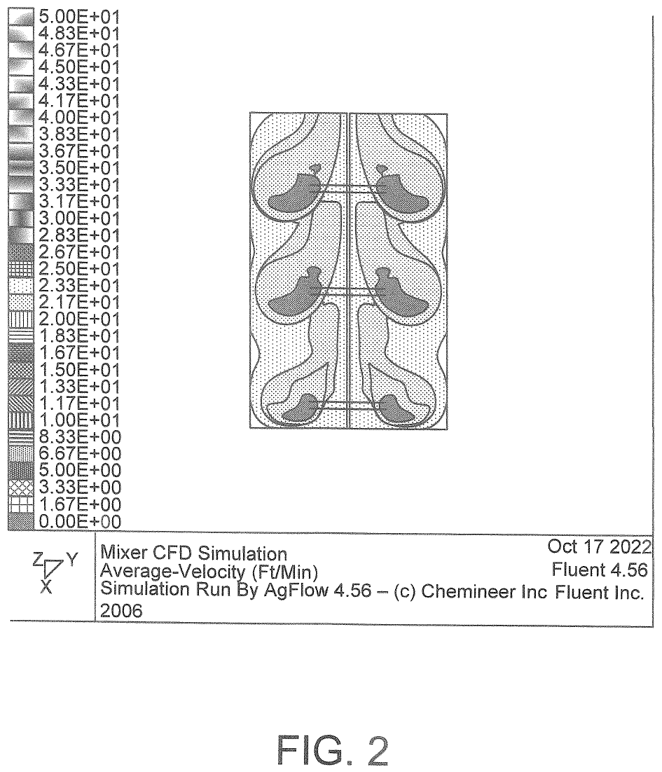

The agitators shown were designed to provide a bulk fluid velocity of 12 ft/min to maintain homogeneity of the pepper mash during agitation while providing the lowest possible shear in order to prevent damage to the pepper solids. The pumping rate for the fermentation agitator is approximately 18,000 GPM compared to the recirculation pump flow rate of 200 GPM. The flow pattern produced by the agitators is illustrated in FIG. 2, produced by simulation. Maximum shaft speed is determined by the shaft length, diameter and weight of impellers. In one embodiment, the speed of the impellers shown was 16.5 rpm. A sealed bearing may be mounted to the bottom of the tank to couple to the shaft to help support the shaft, but in the embodiment of the figures, this was not shown.

Tests were run using a 200,000 lb. shipment of freshly processed pepper mash pumped into one of the 28,900 gallon fermentation tanks described above, through a valved inlet in the bottom of the tank (not shown), and experimentation was done with the agitation process. A mixing schedule found to be adequate was: 12 hours mixing followed by 12 hours rest. This schedule was repeated continuously during the trial. It was also believed beneficial to mix continuously during the initial period of heavy fermentation, about eight days, particularly if the tank headspace is not vacant, but filled with mash.

In twelve days, a pH of 4.1 was achieved, greatly exceeding our expectations on the accelerated fermentation process. We processed an additional 25,000,000 pounds of pepper mash, achieving similar results on pH with mixing each batch. During this process, we also validated that the agitation allows for the loading of more product into fermentation tanks as the agitation promotes the removal of gases from the mash, reducing the risk of volumetric expansion of the mash resulting from entrained gas. This allows for the processing and storage of about 20% more mash in a fermentation tank and consequently, more throughput. The tank was left with a headspace of a few inches to allow CO₂ to escape the tank interior. The shortened fermentation time and additional volume capacity will have a significant impact on the pepper mash supply chain, allowing for more efficient production of pepper mash at larger volumes to support the industry's exponential growth. Additionally, with a homogenized mash, the discharge of fermented mash can be more readily and quickly accomplished, as recycling of the mash through the tank before discharge is not needed.

These tests confirm that agitation during the fermentation process greatly reduces the time needed to accomplish the fermentation process to a target pH. Agitation evenly distributes the LAB and yeast in the pepper mash through the fermentation process, allowing for more rapid conversion of the pepper's sugar into lactic acid and dramatically reducing the amount of time required to achieve a pH of <4.6. This was done with a bulk fluid velocity created by agitation (for instance 12 feet/min) that would expedite the fermentation process by dramatically reducing pepper solid size shearing by the agitator and breaking down the pepper's pectin, without causing damage to the pepper mash. Achieving these results will revolutionize the pepper mash industry, as it would allow approximately 1.5 times the throughput of fermented pepper mash through the infrastructure, with reduced throughput time, allowing for significant efficiency improvements.

The mixing can be achieved by any means that can keep the mash homogenized. Agitation can be achieved by axial flow impellers, a continuous single shaft mixer, paddles, a vertical bladed mixer such as on a hand mixer, a spiral agitator such as used in a washing machine, or any apparatus that will keep the product homogenized over time. Turning tanks can also be utilized, but the turning tank will not affect particle size or viscosity, and would only be appropriate in small tanks, such as oak barrels.

The mixing system and the selected blending schedule are flexible and can be varied to meet the demands of each vendor. By agitating or mixing the mash, the time to produce an acceptable pH has been reduced from 180 days to 40 days. An additional benefit of mixing is that the headspace can be substantially eliminated as there is no separation of the mash solution resulting in expanded volume in the tank. For instance, considering a 30,000-gallon tank containing 3,000 gallons of unused headspace, mixing in the tank allows for substantially the full use of the tank, allowing for an additional 3,000 gallons of pepper mash to be fermented in a batch. A minor headspace (a few inches) can be used to assist venting CO₂.

As used herein, mixing of the pepper mash includes any type of mixing, blending or agitation using any type of mixing, blending or agitation apparatus. A single agitator, multiple agitators can be used. The mixing can be designed to produce the desired particle size and product viscosity of the mash at the end of fermentation. The stirring or blending or mixing or agitating should be sufficient to keep the mash solids in suspension throughput the fermentation period and up to product removal, and not so forceful as to damage the product. As used herein, mixing, blending or agitating are considered to be identical.

The mixing can be continuous, but once production of CO₂ slows, continuous mixing is not necessary to keep a fairly uniform product, and stopping mixing for a time is cost beneficial. Hence, mixing can be continuous, intermittent, or on a schedule, such as 12 hours on, 12 off, to maintain product uniformity. Once the process is complete, there is no need to further mix by using the discharge pump to recycle product through the tank. The fermented mash is then pumped out of the tank through a valved discharge port at the bottom of the tank) not shown) to later be mixed with vinegar and possibly other spices to blend the hot sauce. The fermented mash may be shipped offsite for blending. The mash may also be stored to be used as an ingredient throughout the year to meet production needs, in which case, scheduled agitation of the stored mash is desirable. The mixing or agitation can be on a set schedule, for instance mixing for 1 hour, rest for 12 hours, or any schedule found to maintain product homogeneity in the storage tank and prevent product separation.

Each electric motor can be connected to a control center to implement the agitation schedule for that particular tank. Hence a large tank farm can have each tank agitation automated through the control center.

1. A method of fermenting pepper mash in a fermentation tank comprising the steps of pumping the pepper mash into the tank to ferment, and agitating the pepper mash at times during fermentation, followed by pumping the fermented pepper mash out of the fermentation tank when the pepper mash achieves a preselected target characteristic.

2. The method of claim 1 where the agitation is continuous during the fermentation time.

3. The method of claim 1 where the agitation is undertaken based on a schedule of times.

4. The method of claim 3 where the schedule of times includes a period of agitation followed by a period of no agitation, and repeats during the fermentation.

5. The method of claim 1 where the agitation is continuous for the first period, followed by a schedule of agitation times.

6. The method of claim 1 where the schedule of agitation is performed at times to keep mash solids in suspension.

7. The method of claim 1 where the pepper mash is pumped into the tank so that a headspace in the tank is inches in thickness.

8. The method of claim 1 where the agitation further also shears solids in the pepper mash to reduce their size.

9. A method of storing fermented pepper mash in a storage tank comprising the steps of pumping the fermented pepper mash into the storage tank and agitating the fermented pepper mash at times while stored.

10. A pepper mash fermentation system comprising a closable tank having an interior, the system further having an agitator in the interior of the tank, the agitator coupled to a power source for operating the agitator, the agitator configured to produce a bulk fluid velocity in the pepper mash in the range of 11 feet/sec-15 feet/sec.

11. The system of claim 10 where the power source is connected to a control system configured to operate the agitator according to a schedule stored in the control system.

12. The system of claim 10 where the tank has a center opening in a tank top portion, and the agitator positioned in the center opening, the agitator comprising a shaft having a series of impellers positioned on the shaft in the interior of the tank.

13. The system of claim 12 further having a manway extending across the top of the tank, where the manway is open at the tank center opening.

14. The system of claim 13 where the top end of the agitator shaft extends through the tank center opening, and where the top end of the agitator is coupled to a power source.

15. The system of claim 14, where the top end of the agitator is coupled to a power source through a gearbox.
